(19) United States
(12) Patent Application Publication
(10) Pub. No.: US 2009/0212478 A1
(43) Pub. Date: Aug. 27, 2009

(54) POWER ASSIST DEVICE AND METHOD OF CONTROLLING THE POWER ASSIST DEVICE

(76) Inventor: Hideyuki Murayama, Toyota-shi (JP)

Correspondence Address: KENYON & KENYON LLP, 1500 K STREET N.W., SUITE 700, WASHINGTON, DC, 20005, US

(21) Appl. No.: 12/392,793

(22) Filed: Feb. 25, 2009

(30) Foreign Application Priority Data
Feb. 27, 2008 (JP) 2008-046060

(51) Int. Cl. B23Q 1/64; G06F 19/00

(52) U.S. Cl. 269/56; 700/260

(57) ABSTRACT

A method of controlling a power assist device including a workpiece holding device, a handle, a force sensor that measures operating force of a worker that acts on the handle, a robot arm that supports the workpiece holding device, and a control device that controls an action of the robot arm based on a measurement result of the force sensor. The workpiece holding device includes an angle sensor that measures an inclination angle of the workpiece holding device. An action of robot arm is controlled by the control device based on measurement results of the angle sensor and of the force sensor.

### INCORPORATION BY REFERENCE

The disclosure of Japanese Patent Application No. 2008-046060 filed on Feb. 27, 2008 including the specification, drawings and abstract is incorporated herein by reference in its entirety.

### BACKGROUND OF THE INVENTION

1. Field of the Invention

The present invention relates to a power assist device, and more particularly to a power assist device and a method of controlling the power assist device.

2. Description of the Related Art

Power assist devices are used as devices for supporting conveyance of heavy objects (workpieces) by worker on production sites and so forth of industrial products. Operation of assembling workpieces includes conveyance and positioning of workpieces. The worker and the power assist device can cooperatively transfer the workpieces, and the power assist device can be burdened with the force required for transferring the workpiece. The worker can effectively position the workpiece by teaching the positioning of the workpiece to the power assist device. In other words, the purpose of using the power assist device is to reduce labor of workers and to improve work efficiency.

It is known with a power assist device that includes a drive mechanism such as a motor and an actuator for each of a plurality of arms and a sensor for detecting operating force applied to the arm for each of the arms. For example, Japanese Patent Application Publication No. 11-198077 (JP-A-11-198077) discloses such a power assist device. In the power assist device, the worker operates the arm in a desired direction. The operating force is measured by the sensor installed in each arm. Operating force equivalent to the operating force measured by the sensor is generated by the drive mechanism. Thereby, the worker can transfer a workpiece by operation with smaller force.

However, the power assist device of the related art has a problem that the worker has difficulty in operability in the case that the workpiece is conveyed in an inclined state. The worker experiences difficulty in operability of the power assist device because such circumstances occur that force required by the worker for operation (operating force) is large and that the operating direction desired by the worker does not correspond with the direction that the workpiece is actually displaced, for example.

Now, the power assist device of the related art will be described with reference to FIGS. 6 through 9. FIG. 6 is a schematic view showing a general structure of the power assist device of the related art. FIG. 7A is a schematic plan view showing a general structure of a workpiece holding device of the related art. FIG. 7B is a schematic side view showing the general structure of the workpiece holding device of the related art. FIG. 8 is a perspective view showing a mounted state of a force sensor of the related art. FIG. 9 is a schematic view showing a connected state of a control device of the related art. For convenience of description, assuming that the power assist device is provided in the XYZ coordinate system shown in FIG. 6, descriptions will be made hereinafter with rotations around the X-axis, Y-axis, and Z-axis defined as roll rotation, pitch rotation, and yaw rotation, respectively.

As shown in FIG. 6, a power assist device 21 of the related art includes a robot arm 22, a workpiece holding device 23, a free joint 24, and a control device 25. The robot arm 22 described in the related art is supported by a hoist 27 to be capable of traveling in the X-axis direction.

As shown in FIGS. 7A and 7B, the workpiece holding device 23 includes a substantially plate-shaped main body 23a, suction cups 23b, 23b . . . which are holding parts for a windshield 30 as a conveyed object (workpiece), handles 23c, 23c, force sensors 23d, 23d, and contact pressure sensors 23e, 23e . . . The workpiece holding device 23 is coupled to the robot arm 22 via the free joint 24 that is fixedly installed in the main body 23a.

The suction cups 23b, 23b . . . are capable of turning on and off of a sucking action. The contact pressure sensors 23e, 23e . . . are installed in the suction cups 23b, 23b . . . , and measure pressure (reaction force) that the windshield 30 sucked to and held on the suction cups receives in contacting with the external environment.

As shown in FIGS. 7A and 7B, the force sensors 23d, 23d are installed in base parts of the handles 23c, 23c which are grippers for the worker. As shown in FIG. 8, the aβγ coordinate system is designated in the force sensor 23d as a reference for expressing measurement values of the force sensor 23d. The operating force of the worker in the a-axis direction, β-axis direction, and γ-axis direction are respectively denoted by Fa, Fβ, and Fγ. The measurement values of the force sensor 23d in the a-axis direction, β-axis direction, and γ-axis direction are respectively denoted by Sa, Sβ, and Sγ. In the descriptions hereinafter, a case that the operating force of the worker does not act on the β-axis direction will be described for convenience.

The free joint 24 is a joint member that is constructed to be capable of rotating in each of roll, pitch, and yaw rotational directions without interfering with each other. The free joint 24 also includes a brake mechanism 24a. The brake mechanism 24a regulates rotation in each of roll, pitch, and yaw rotational directions independently of each other according to an instruction from the control device 25.

As shown in FIG. 9, the control device 25 is connected to an actuator 22a and a motor 22b of the robot arm 22, and the position of the robot arm 22 is controlled according to the instruction from the control device 25. The control device 25 is connected to the force sensors 23d, 23d of the workpiece holding device 23. The control device 25 calculates operating direction, operation amount, operating speed, and so forth when the worker holds the handles 23c, 23c and operates the workpiece holding device 23 in a desired direction.

In other words, when the control device 25 receives measurement values (Sa, Sγ) from the force sensors 23d, 23d, the control device 25 estimates the operating force (Fa, Fγ) of the worker based on the measurement values (Sa, Sγ), determines operation desired by the worker (operating direction, operation amount, operating speed, and so forth), and controls operation of the actuator 22a and the motor 22b, thereby controlling the position of the robot arm 22. A construction having a 6-component load force sensor is known with the force sensors 23d, 23d.

Now, a workpiece holding state of the power assist device of the related art will be described with reference to FIG. 10. FIG. 10A is a schematic view showing a state that the power assist device of the related art horizontally holds a workpiece. FIG. 10B is a schematic view showing a state that the power assist device of the related art holds the workpiece in an inclined state. The power assist device 21 includes the handles 23c, 23c and the force sensors 23d, 23d in two sides opposed to each other in the workpiece holding device 23. However, descriptions will be made hereinafter with a focus on the handle 23c and the force sensor 23d in one side for convenience.

As shown in FIG. 10A, in the power assist device 21 of the related art, a gravitational force Mg acts on the handle 23c if the handle 23c has a weight M in a state that the workpiece holding device 23 horizontally holds the windshield 30. The measurement values (Sa, Sγ) of the gravitational force Mg measured by the force sensor 23d are as follows:

Sa=0, Sγ=−Mg

In the related art, an offset value (+Mg) is set for the operating force Fγ in the γ-axis direction estimated with the measurement value Sγ from the force sensor 23d in consideration of the gravitational force Mg that acts on the handle 23c. In other words, the operating force (Fa, Fγ) of the worker is obtained by the control device 25 according to the following equation.

Fa=Sa, Fγ=Sγ+Mg

Thus, the operating force (Fa, Fγ) of the worker can be accurately estimated by the control device 25 based on the measurement values (Sa, Sγ) from the force sensor 23d in the state that the workpiece holding device 23 horizontally holds the windshield 30.

However, as shown in FIG. 10B, in a state that the workpiece holding device 23 holds the windshield 30 as the workpiece while it is inclined at an angle θ, the force sensors 23d for measuring the operating force, the handles 23c, and the like in the power assist device 21 are also inclined together with the workpiece. At this point, the gravitational force Mg that acts on the handle 23c is also exerted on the force sensor 23d. The measurement values (Sa, Sγ) of the gravitational force Mg measured by the force sensor 23d are as follows:

Sa=−Mg sinθ, Sγ=−Mg cosθ

In other words, the measurement values (Sa, Sγ) reflect the influence of the gravitational force Mg in accordance with the inclination angle θ of the workpiece holding device 23. However, in the related art, the inclination angle θ of the workpiece holding device 23 is not taken into consideration in obtaining the offset value.

Therefore, as the power assist device 21 only setting the offset value (+Mg) for the operating force Fγ estimated based on the measurement value Sγ of the force sensor 23d in the γ axis direction in consideration of the gravitational force Mg applied to the handle 23c, does not allow accurate estimation of the operating force (Fa, Fγ) of the worker in the state that the workpiece holding device 23 holds the windshield 30 while it is inclined at the angle θ.

Furthermore, if the operating force (Fa, Fγ) of the worker cannot be accurately estimated, then an assist amount required by the power assist device 21, which is calculated by the control device 25, cannot be successfully derived. This results in circumstances that force that the worker requires for operation (operating force) becomes large and that an operating direction desired by the worker does not correspond with a direction that the windshield 30 is practically displaced, thus deteriorating operability of the power assist device.

Therefore, it is difficult with the power assist device of the related art to convey the workpiece in a desired direction and to obtain accuracy in positioning in the case that the workpiece is conveyed in the inclined state. Further, there is a problem that positioning of the workpiece consumes time and efficiency in conveyance is not improved as intended.

### SUMMARY OF THE INVENTION

The present invention provides a power assist device and a method of controlling the power assist device that can secure accuracy in positioning and improvement in efficiency in conveyance even when a workpiece is conveyed in a inclined state. Specifically, the present invention provides a power assist device and a method of controlling the power assist device that has good operability and that force that a worker requires for operation (operating force) is small and a operating direction desired by the worker corresponds with a direction in which the workpiece is actually displaced even when the workpiece is conveyed in an inclined state.

A first aspect of the present invention relates to a power assist device including a workpiece holding device that holds a workpiece, a handle that is provided in the workpiece holding device and adapted to be an operating part operated by a worker, a force sensor that is provided in the workpiece holding device and measures operating force of the worker acts on the handle, a robot arm that supports the workpiece holding device, and a control device that controls an action of the robot arm based on a measurement result of the force sensor. In the power assist device, the workpiece holding device includes an angle sensor that measures an inclination angle of the workpiece holding device. The control device corrects the measurement result of the force sensor based on a measurement result of the angle sensor and controls an action of the robot arm based on an a corrected measurement result of the force sensor.

The control device may calculate the offset value based on the measurement result of the angle sensor and the weight of the handle and further the measurement result of the force sensor and the offset value together to calculate the corrected measurement result of the force sensor.

A second aspect of the present invention relates to a method of controlling a power assist device including a workpiece holding device a workpiece, a handle that is provided in the workpiece holding device and adapted to be an operating part operated by a worker, a force sensor that is provided in the workpiece holding device and measures operating force of the worker that acts on the handle, a robot arm that supports the workpiece holding device, and a control device that controls an action of the robot arm based on a measurement result of the force sensor. The workpiece holding device includes an angle sensor that measures an inclination angle of the workpiece holding device. The control device corrects the measurement result of the force sensor based on a measurement result of the angle sensor and controls an action of the robot arm based on an corrected measurement result of the force sensor.

The control device calculates the offset value based on the measurement result of the angle sensor and the weight of the handle, and further adds the measurement result of the force sensor and the offset value together to calculate the corrected measurement result of the force sensor.

In a case that the workpiece is transferred by the power assist device in an inclined state, the operating force of the worker can be appropriately adjusted in response to the inclination angle, and the operating force of the worker can be accurately estimated. This allows reduction in the operating force of the worker and correspondence between the operating direction desired by the worker and an actual direction of conveyance, thus improving efficiency in conveyance by the power assist device.

Correction of the measurement value of the force sensor is facilitated, thus allowing accurate estimation of the operating force of the worker.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a schematic view showing a general structure of a power assist device in accordance with an embodiment of the present invention;

FIG. 2A is a schematic plan view showing a general structure of a workpiece holding device in accordance with the embodiment of the present invention, and FIG. 2B is a schematic side view showing the general structure of the workpiece holding device in accordance with the embodiment of the present invention;

FIG. 3 is a perspective view showing a mounted state of a force sensor in accordance with the embodiment of the present invention;

FIG. 4 is a schematic view showing a connected state of a control device in accordance with the embodiment of the present invention;

FIG. 5A is a schematic view showing a state that the power assist device in accordance with the embodiment of the present invention horizontally holds a workpiece, and FIG. 5B is a schematic view showing a state that the power assist device in accordance with the embodiment of the present invention holds the workpiece in an inclined state;

FIG. 6 is a schematic view showing a general structure of a power assist device of a related art;

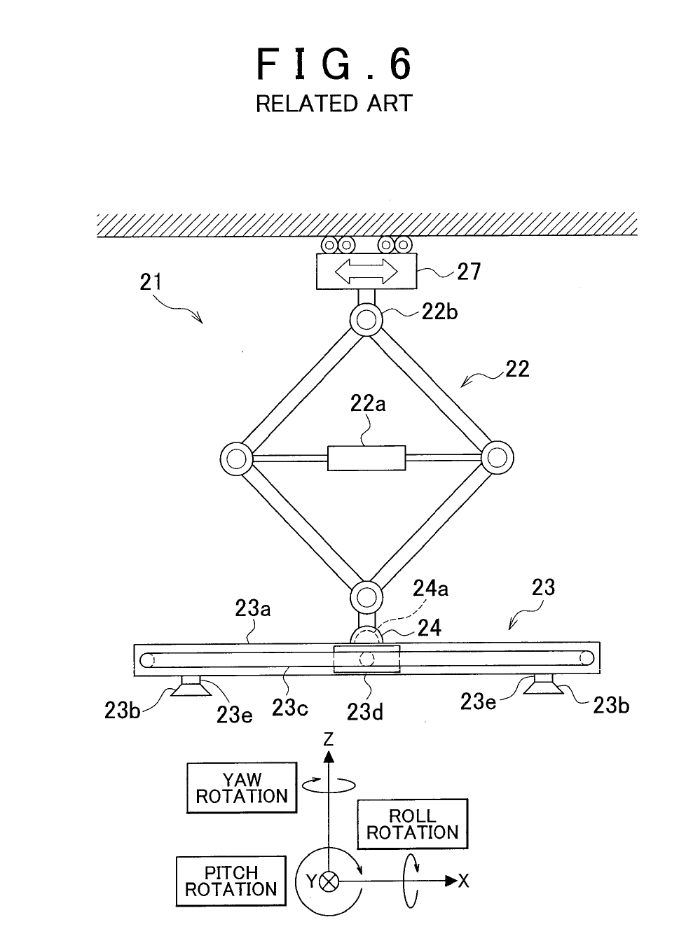

FIG. 7A is a schematic plan view showing a general structure of a workpiece holding device of the related art, and FIG. 7B is a schematic side view showing the general structure of the workpiece holding device of the related art;

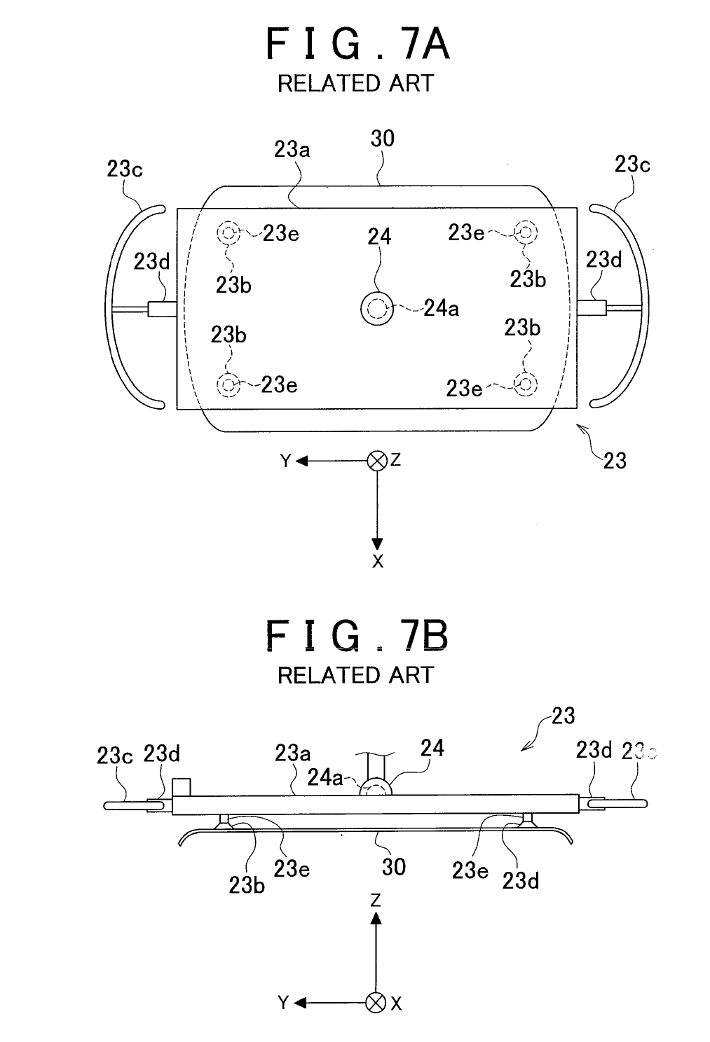

FIG. 8 is a perspective view showing a mounted state of a force sensor of the related art;

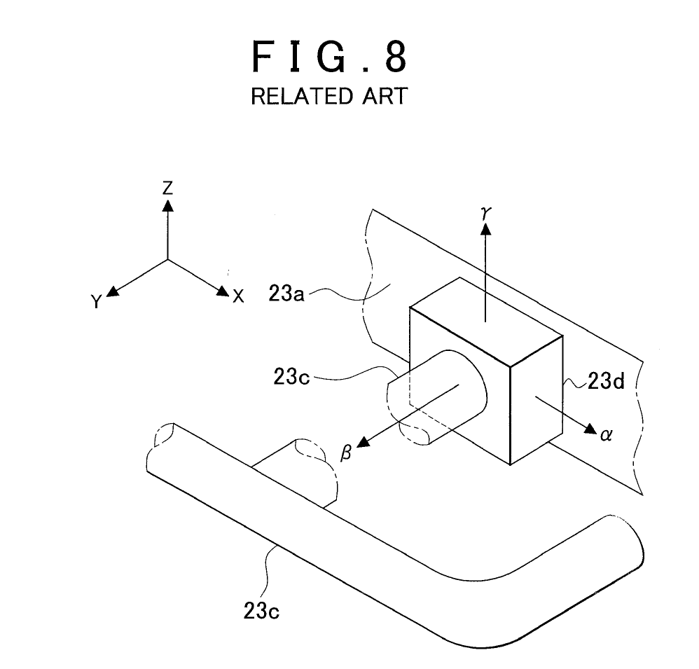

FIG. 9 is a schematic view showing a connected state of a control device of the related art; and

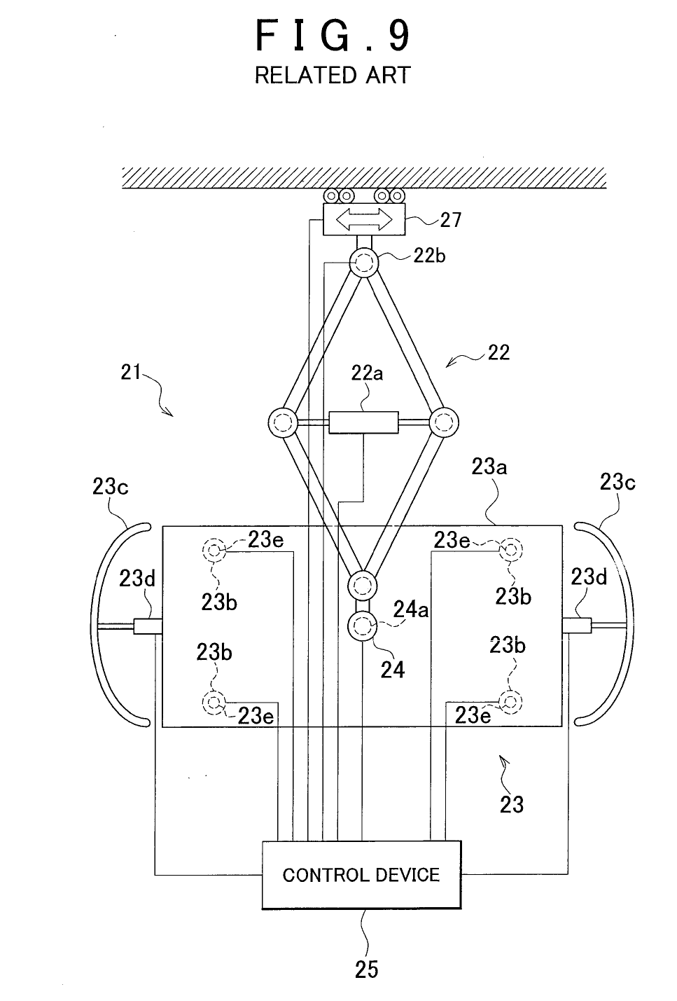

FIG. 10A is a schematic view showing a state that the power assist device of the related art horizontally holds a workpiece, and FIG. 10B is a schematic view showing a state that the power assist device of the related art holds the workpiece in an inclined state.

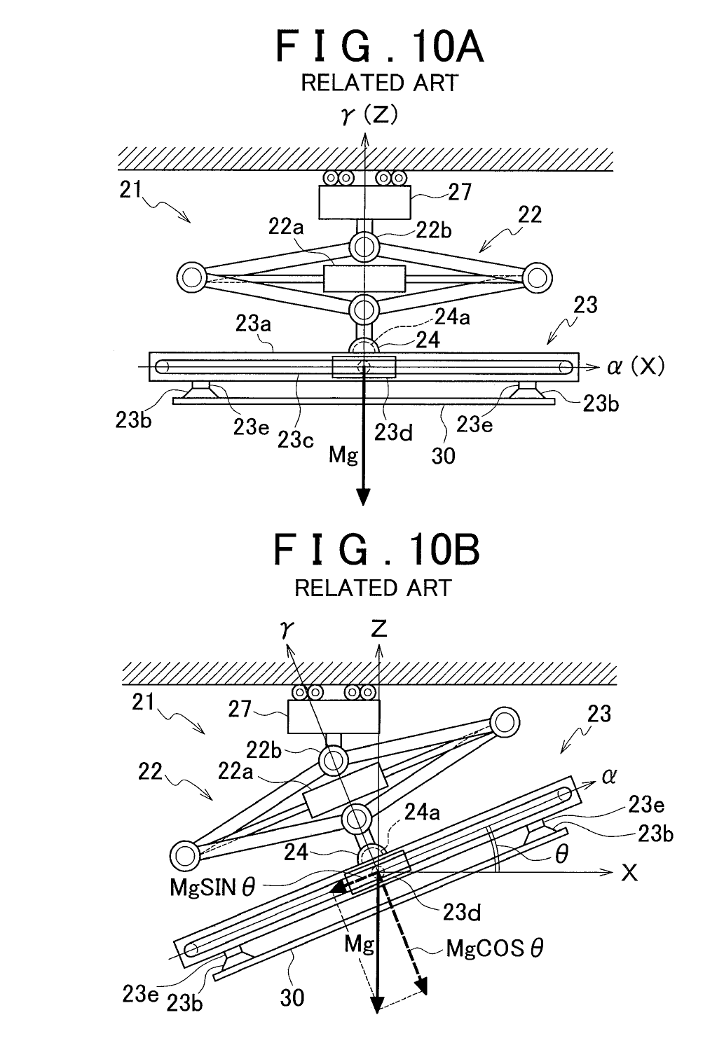

### DETAILED DESCRIPTION OF THE EMBODIMENTS

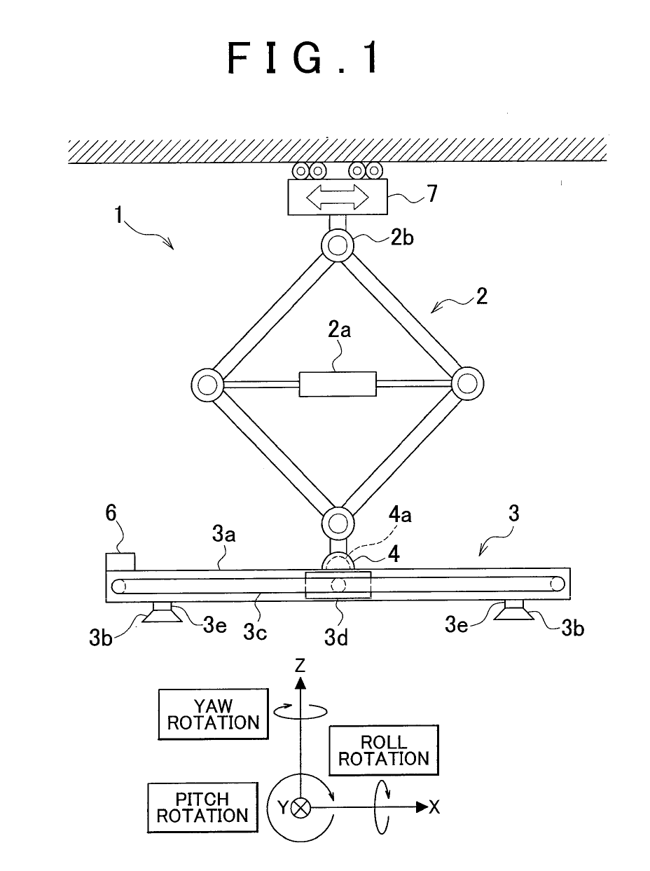

A power assist device in accordance with an embodiment of the present invention will be described with reference to FIGS. 1 through 4. For convenience of description, assuming that the power assist device 1 is provided in the XYZ coordinate system shown in FIG. 1, descriptions will be made hereinafter with rotations around the X-axis, Y-axis, and Z-axis defined as roll rotation, pitch rotation, and yaw rotation, respectively.

As shown in FIG. 1, a power assist device 1 in accordance with the embodiment of the present invention includes, similarly to the power assist device 21 of the related art, with a robot arm 2, a workpiece holding device 3, a free joint 4, a control device 5, and an angle sensor 6.

The robot arm 2 described in this embodiment is supported by a hoist 7 to be capable of traveling in the X-axis direction. The robot arm used for the power assist device 1 to which the present invention is applied is not limited to the robot arm 2 that has an arm shape described in this embodiment, but a robot arm of another structure may be used.

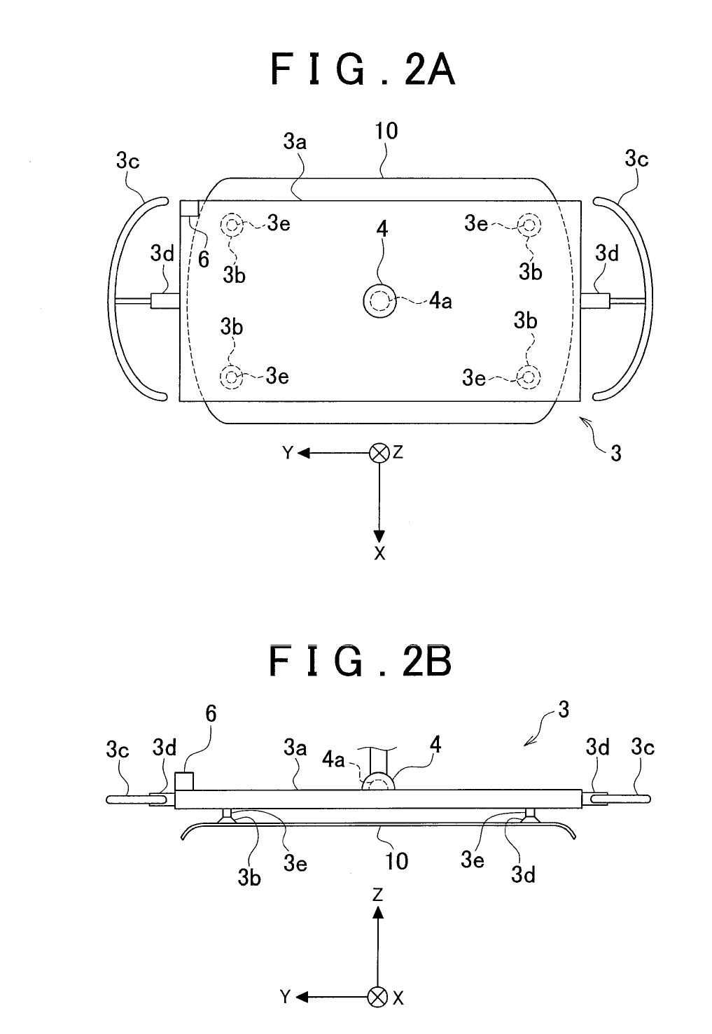

As shown in FIGS. 1, 2A, and 2B, the workpiece holding device 3, similarly to the workpiece holding device 23 of the related art, includes a substantially plate-shaped main body 3a, suction cups 3b, 3b . . . which are holding parts for a windshield 10 as a conveyed object (workpiece), handles 3c, 3c, force sensors 3d, 3d, and contact pressure sensors 3e, 3e . . . The workpiece holding device 3 is coupled to the robot arm 2 via the free joint 4 that is fixedly installed in the main body 3a.

The suction cups 3b, 3b . . . are capable of turning on and off of action. The contact pressure sensors 3e, 3e . . . are installed in the suction cups 3b, 3b . . . , and measure pressure (reaction force) that the windshield 10 sucked to and held on the suction cups receives in contacting with the external environment.

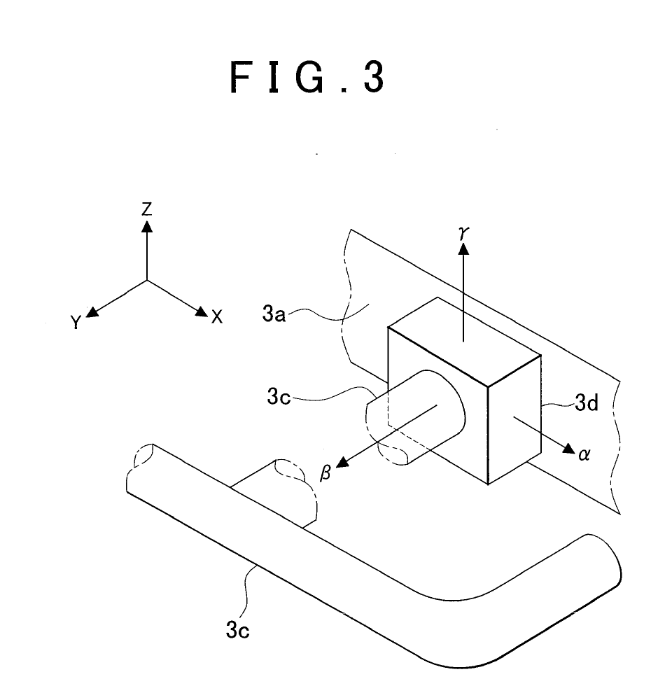

As shown in FIGS. 2A and 2B, the force sensors 3d, 3d are installed in base parts of the handles 3c, 3c which are grippers for a worker. As shown in FIG. 3, similarly to the force sensor 23d of the related art, the aβγ coordinate system is designated in the force sensor 3d as a reference for expressing measurement values of the force sensor 3d. The operating force of the worker in a-axis direction, β-axis direction, and γ-axis direction are denoted by Fa, Fβ, and Fγ. The measurement values of the force sensor 3d in the a-axis direction, β-axis direction, and γ-axis direction are denoted by Sa, Sβ, and Sγ, respectively. In other words, the force sensor 3d is capable of measuring the operating force of the worker as a component in each of the a, β, and γ-axis directions. However, in the descriptions hereinafter, a case that the operating force of the worker does not act on the β-axis direction will be described for convenience.

The free joint 4 is a joint member that is constructed to be capable of rotating in each of roll, pitch, and yaw rotational directions without interfering with each other. The free joint 4 also includes a brake mechanism 4a. The brake mechanism 4a regulates rotation in each of roll, pitch, and yaw rotational directions independently of each other according to an instruction from the control device 5.

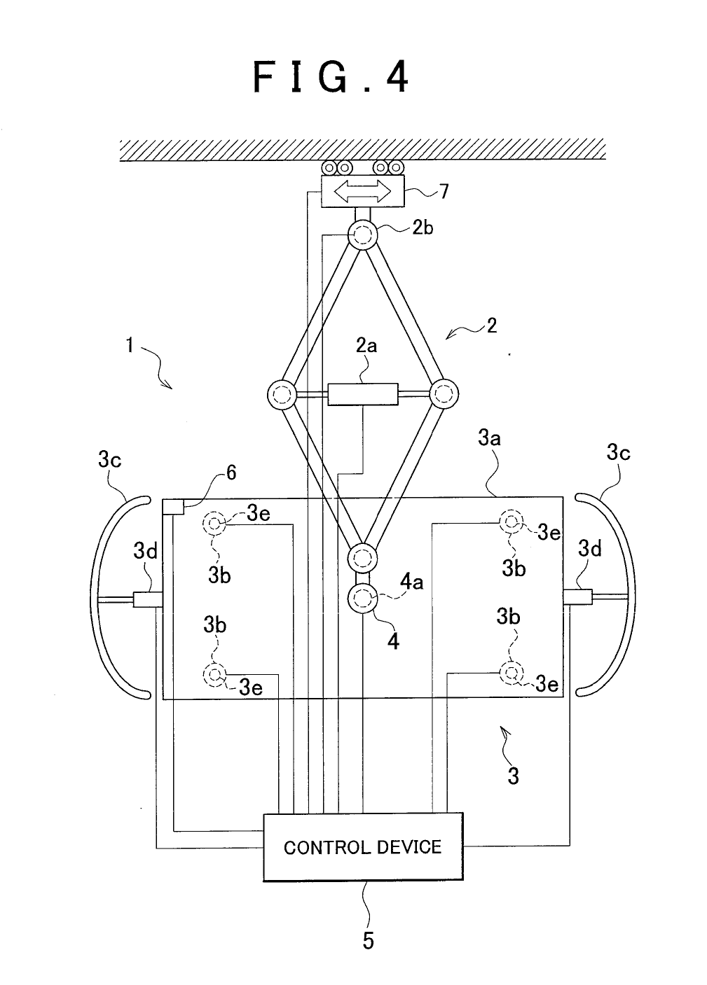

As shown in FIG. 4, the control device 5 is connected to an actuator 2a and a motor 2b of the robot arm 2, and the position of the robot arm 2 is controlled according to the instruction from the control device 5. The control device 5 is connected to the force sensors 3d, 3d of the workpiece holding device 3. The control device 5 calculates operating direction, operation amount, operating speed, and so forth based on the measurement values from the force sensors 3d, 3d when the worker holds the handles 3c, 3c and operates the workpiece holding device 3 in a desired direction.

In other words, when the control device 5 receives measurement values (Sa, Sγ) from the force sensors 3d, 3d, the control device 5 estimates the operating force (Fa, Fγ) of the worker based on the measurement values (Sa, Sγ), determines operation desired by the worker (operating direction, operation amount, operating speed, and so forth), and controls operation of the actuator 2a and the motor 2b, thereby controlling the position of the robot arm 2.

The angle sensor 6 functioning as an angle measuring device is fixedly installed in the workpiece holding device 3 and measures an inclination angle θ of the workpiece holding device 3. The angle sensor 6 is connected to the control device 5. The control device 5 receives a measurement result about the inclination angle θ of the workpiece holding device 3 measured by the angle sensor 6. Thereby, the control device 5 calculates inclination angles of the workpiece holding device 3 in roll, pitch, and yaw directions in the XYZ coordinate system. In this embodiment, the workpiece holding device 3 is adapted to include the angle sensor 6, and the angle sensor 6 measures the angles of the workpiece holding device 3 in roll, pitch, and yaw directions in the XYZ coordinate system. However, the control device 5 may calculate the inclination angles of the workpiece holding device 3 from information about positions of the robot arm 2 and the free joint 4, for example. The present invention is not limited by a method of measuring an inclination angle of the workpiece holding device 3.

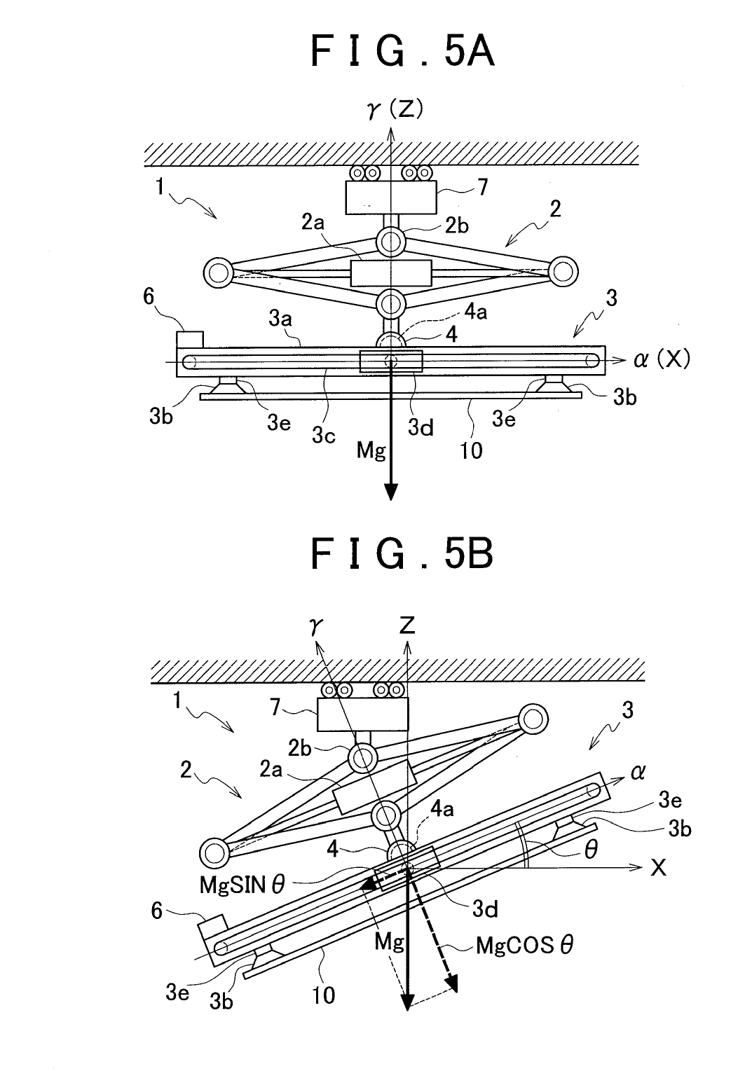

Now, a workpiece holding state by the power assist device in accordance with the embodiment of the present invention will be described with reference to FIG. 5. The power assist device 1 includes the handles 3c, 3c and the force sensors 3d, 3d in two sides opposed to each other in the workpiece holding device 3. However, descriptions will be made hereinafter with a focus on the handle 3c and the force sensor 3d in one side for convenience.

As shown in FIG. 5A, in the power assist device 1 in accordance with the embodiment of the present invention, similarly to the power assist device 21 of the related art, a gravitational force Mg acts on the handle 3c if the handle 3c has a weight M in a state that the workpiece holding device 3 horizontally holds the windshield 10. Measurement values (Sa, Sγ) of the gravitational force Mg measured by the force sensor 3d are as follows:

Sa=0, Sγ=−Mg

In the power assist device 1, an offset value (+Mg) is set for the operating force Fγ in the γ-axis direction estimated with the measurement value Sγ from the force sensor 3d in consideration of the gravitational force Mg that acts on the handle 3c. In other words, in the power assist device 1 in accordance with the embodiment of the present invention, the operating force (Fa, Fγ) of the worker can be obtained by the control device 5 according to the following equation in the state that the workpiece holding device 3 horizontally holds the windshield 10.

Fa=Sa, Fγ=Sγ+Mg

As shown in FIG. 5B, in a state that the workpiece holding device 3 holds the windshield 10 while it is inclined in the pitch direction at an angle θ, the force sensors 3d for measuring the operating force, the handles 3c, and the like in the power assist device 1 are also inclined in the pitch direction together with the workpiece. At this point, the gravitational force Mg that acts on the handle 3c is also exerted on the force sensor 3d. The measurement values (Sa, Sγ) of the gravitational force Mg measured by the force sensor 3d are as follows:

Sa=−Mg sinθ, Sγ=−Mg cosθ

Therefore, the offset value in accordance with the inclination angle θ of the workpiece holding device 3 is set for the measurement values (Sa, Sγ) of the force sensor 3d in consideration of a component in the a axis direction (−Mg sinθ) and a component in the γ-axis direction (31 Mg cosθ) of the gravitational force Mg that acts on the handle 3c.

Now, a method of setting the offset value will be described. First, the offset value described above is set in the state that the workpiece holding device 3 horizontally holds the windshield 10. In other words, the offset value (+Mg) is set for the operating force Fγ in the γ-direction. The operating force (Fa, Fγ) is obtained by the control device 5 according to the following equation.

Fa=Sa, Fγ=Sγ+Mg

Next, the workpiece holding device 3 is inclined at the angle θ in a state that the offset value (+Mg) has been set for the operating force Fγ in the γ-direction. Each of measurement values (Saθ, Sγθ) of the force sensor 3d is now as follows:

Saθ=−Mg sinθ, Sγθ=Mg−Mg cosθ

Further, measurement the values (Saθ, Sγθ) at this point are set as the offset values. In other words, corrected operating force (Ha, Hγ) in which components of the gravitational force has been removed from the measurement values (Sa, Sγ) is provided by the following equation.

Ha=Sa−Saθ=Sa−(−Mg sinθ)=Sa+Mg sinθ, Hγ=Sγ−Sγθ=Sγ−(Mg−Mg cosθ)=Sγ−Mg (1−cosθ)

The control device 5 obtains the corrected operating force (Ha, Hγ) from the measurement values (Sa, Sγ) of the force sensor 3d and the measurement value (angle θ) of the angle sensor 6 according to the above equation. Further, the control device 5 determines operation desired by the worker (operating direction, operation amount, operating speed, and so forth) based on the obtained corrected operating force (Ha, Hγ), and controls operation of the actuator 2a and the motor 2b to control the position of the robot arm 2.

That is, the control device 5 calculates the offset values based on the measurement result (angle θ) of the angle sensor 6 and the weight M of the handle 3c, and further adds the measurement result (i.e., measurement values (Sa, Sγ)) and the offset values together to calculate corrected measurement result (i.e., corrected measurement values (Ha, Hγ)) of the force sensor 3d. Such a configuration facilitates corrected of the measurement values (Sa, Sγ) of the force sensor 3d, thus allowing accurate estimation of the operating force (Fa, Fγ) of the worker.

The power assist device 1 and the method of controlling the power assist device 1 in accordance with the embodiment of the present invention are directed to the power assist device 1 and a method of controlling the power assist device 1 including the workpiece holding device 3 that holds the windshield 10 as a workpiece, the handles 3c that is provided in the workpiece holding device 3 and adapted to be operating parts operated by the worker, the force sensors 3d that is provided in the workpiece holding device 3 and measures the operating force (Fa, Fγ) of the worker that acts on the handles 3c, the robot arm 2 that supports the workpiece holding device 3, and the control device 5 that a controls an action of the robot arm 2 based on the measurement results (Sa, Sγ) of the force sensors 3d. The workpiece holding device 3 includes the angle sensor 6 that measures the inclination angle of the workpiece holding device 3. The control device 5 corrects the measurement results (i.e., measurement values (Sa, Sγ)) of the force sensors 3d based on the measurement result (angle θ) of the angle sensor 6 and controls an action of the robot arm 2 based on the corrected measurement results (i.e., corrected measurement values (Ha, Hγ)) of the force sensors 3d.

Such a configuration allows appropriate correction of the operating force (Fa, Fγ) of the worker in accordance with the inclination angle θ (thus allows obtainment of the corrected operating force (Ha, Hγ)) in the case that the windshield (i.e., workpiece) 10 is conveyed by the power assist device 1 in the inclined state. Accordingly, the operating force of the worker can be accurately estimated by the control device 5, thus allowing reduction in the operating force (Fa, Fγ) of the worker and correspondence between the operating direction desired by the worker and an actual direction of conveyance. Therefore, efficiency in conveyance by the power assist device 1 can be improved. In this embodiment, descriptions are made about a case that the operating force of the worker does not act on the β-axis direction for convenience. However, an action of the robot arm 2 can be controlled likewise in a case that the operating force of the worker acts on all of the a-, β-, and γ-axis directions.

While the invention has been described with reference to what are considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single element, are also within the scope of the invention.

What is claimed is:

1. A power assist device comprising:
a workpiece holding device that holds a workpiece;
a handle that is provided in the workpiece holding device and adapted to be an operating part operated by a worker;
a force sensor that is provided in the workpiece holding device and measures operating force of the worker that acts on the handle;
a robot arm that supports the workpiece holding device;
a control device that controls an action of the robot arm based on a measurement result of the force sensor; and
an angle measuring device that is provided in the workpiece holding device and measures an inclination angle of the workpiece holding device,
wherein the control device corrects the measurement result of the force sensor based on a measurement result of the angle measuring device and controls an action of the robot arm based on a corrected measurement result of the force sensor

2. The power assist device according to claim 1, wherein the control device calculates an offset value based on the measurement result of the angle measuring device and a weight of the handle, and adds the measurement result of the force sensor and the offset value together to calculate the corrected measurement result of the force sensor.

3. The power assist device according to claim 1, further comprising
a drive unit that applies driving force to the robot arm,
wherein the control device controls an action of the robot arm by controlling the drive unit.

4. The power assist device according to claim 1, further comprising
a joint member that couples the workpiece holding device and the robot arm together and freely rotates with respect to each of rotational directions of roll, pitch, and yaw.

5. The power assist device according to claim 1, wherein the angle measuring device is an angle sensor that measures an angle of the workpiece holding device in roll, pitch, or yaw direction in an XYZ coordinate system.

6. The power assist device according to claim 4, wherein the angle measuring device measures the inclination angle of the workpiece holding device with information about positions of the robot arm and the joint member.

7. The power assist device according to claim 2, wherein the offset value is set in consideration of a component of the gravitational force that acts on the handle in each axial direction in the XYZ coordinate system.

8. A method of controlling a power assist device comprising:
measuring operating force of a worker that acts on a handle provided in a workpiece holding device that holds a workpiece;
measuring an inclination angle of the workpiece holding device;
correcting a measured operating force based on a measured inclination angle; and
controlling an action of the robot arm based on a corrected operating force.

9. The method of controlling the power assist device according to claim 8, further comprising:
calculating an offset value based on the measured inclination angle and a weight of the handle; and
calculating the corrected operating force by adding the measured operating force and the offset value together.
